(19) United States
(12) Patent Application Publication
(10) Pub. No.: US 2010/0255861 A1
(43) Pub. Date: Oct. 7, 2010

(54) System and Method for Transferring Contact Information to a Recipient

(76) Inventors: Tal Shlomo Raviv, Boca Raton, FL (US); Ariel Natan Chaim Allon, Elkins Park, PA (US); Anton Bemstein, New York, NY (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/417,973

(22) Filed: Apr. 3, 2009

(51) Int. Cl. H04W 4/12

(52) U.S. Cl. 455/466

(57) ABSTRACT

People want to connect, meet, and follow-up with much more information than a phone number, a business card and an email address. The dropcard system and method enables an individual to immediately send contact and other information using a mobile phone. The sender can use virtually any mobile phone to make a request from a server, which emails the recipient with relevant information. Use of the system is universal because only the sender needs to have this technology, and almost any phone has the ability to request the information. The recipient only needs an email address.

### BACKGROUND OF THE INVENTION

1. Field of Invention

This invention relates generally to information sharing, and more particularly, to electronically sharing contact, business and personal history quickly from a user to an identified recipient.

2. Description of Related Art

People connect, meet, and follow-up with much more information than a phone number, a business card and an email address. When people connect in a business or social setting, they may wish to transfer electronic information to one another, such as contact information, websites, brochures, digital photos, resumes and electronic business cards. However, until now, conveniently sharing this type of information in such settings has been difficult or impractical.

Traditional business cards are limited in terms of the form and substance of the information that they provide. Moreover, if a recipient of a traditional business card wishes to convert the information contained thereon into an electronic format, (s)he must do so manually. Also, traditional business cards may be easily misplaced. Accordingly, traditional business cards leave much to be desired. Other methods of transferring electronic information between people in a business or social setting, such as beaming between phones, does not suffice. In short, the ability to capture interactions, follow up immediately, and share business materials is limited to physical transfer or later electronic follow up.

Many electronic ways of sharing contact information are limited by factors such as compatibility requirements, applicability, user population, and convenience. For example, some methods of information transfer require that both recipient and sender have the same hardware and/or software. Such methods transfer information directly from mobile hardware to mobile hardware, and require active participation by both parties. Prior to the invention described and claimed herein, a convenient and universal option was missing.

### BRIEF SUMMARY OF THE INVENTION

In accordance with the exemplary embodiments, the invention includes a dropcard system that enables a user to send an electronic dropcard using a phone to a recipient's electronic address. The system includes a website, a first server and a gateway. The website is accessible to the user for setting up an account for the user. The account includes an identification string and profile information of the user. The first server is in communication with the website and has a processor and a memory unit storing a database and server-side scripts. The server stores the identification string and profile information of the user and creates a VCF vCard based on the stored profile information. The gateway is in communication with the first server and receives an SMS message initiated from the phone. The gateway forwards the SMS message to the first server. The SMS message includes a phone number associated with the user and an electronic address of the recipient. The server-side scripts match the phone number with the identification string stored in the server, parse the SMS message for data relevant to contact information of the recipient and for user selected instructions for identifying user information in the database, save the parsed SMS message in the database, collect profile information of the user from the database based on the user information identified by the selected instructions as an electronic dropcard, and send the electronic dropcard to the electronic address of the recipient.

In accordance with the exemplary embodiments, the invention also includes a method for sending an electronic dropcard initiated by a phone call to a recipient's electronic address. The method includes: receiving an SMS message at a server from a phone making the phone call, the SMS message including a phone number associated with the phone, user selected instructions and an electronic address associated with a recipient; matching the phone number with an identification string stored in a database of the server, the identification string associated with a user of the phone initiating the phone call; parsing the SMS message for the electronic address of the recipient and for user selected instructions for identifying profile information of the user in the database; saving the parsed SMS message in the database; collecting the profile information of the user from the database based on the user information identified by the selected instructions as an electronic dropcard; and sending the electronic dropcard to the electronic address of the recipient.

In accordance with the exemplary embodiments, the invention further includes a server having a database and a processor running server-side scripts for sending an electronic dropcard initiated by a phone call to a recipient's electronic address, with the server receiving an SMS message at a server from a phone making the phone call, the SMS message including a phone number associated with the phone, user selected instructions and an electronic address associated with a recipient, matching the phone number with an identification string stored in the database, the identification string associated with a user of the phone initiating the phone call, parsing the SMS message for the electronic address of the recipient and for user selected instructions for identifying profile information of the user in the database, saving the parsed SMS message in the database, collecting the profile information of the user from the database based on the user information identified by the selected instructions as an electronic dropcard, and sending the electronic dropcard to the electronic address of the recipient.

### BRIEF DESCRIPTION OF SEVERAL VIEWS OF THE DRAWINGS

The invention will be described in conjunction with the following drawings in which like reference numerals designate like elements and wherein:

FIG. 1 is a diagram showing an exemplary structure of the preferred embodiments of the invention;

FIG. 2 is an exemplary login page;

FIG. 3 is an exemplary sign-up page;

FIG. 4 is an exemplary profile management page;

FIG. 5 is an exemplary management page showing drop down/up menus;

FIG. 6 is an exemplary send dropcard page;

FIG. 7 is an exemplary profile analytics page;

FIG. 8 is an exemplary contact list page; and

FIG. 9 is an exemplary imports contact page.

### DETAILED DESCRIPTION OF THE INVENTION

The invention disclosed by examples herein includes a dropcard system and method for enabling an individual to immediately send contact and other information using a mobile phone. It is understood that the term “dropcard” refers a grouping of electronic data, files and hyperlinks for transmission. While not being limited to a particular theory, a dropcard includes email, contact information, links to websites, social networks, pre-saved profile information and additional messages that the user wants to include. The sender can use virtually any mobile phone to make a request from a server, which emails the recipient with relevant information. Use of the system is universal because only the sender needs to have this technology, and almost any phone has the ability to request the information. The recipient only needs an email address.

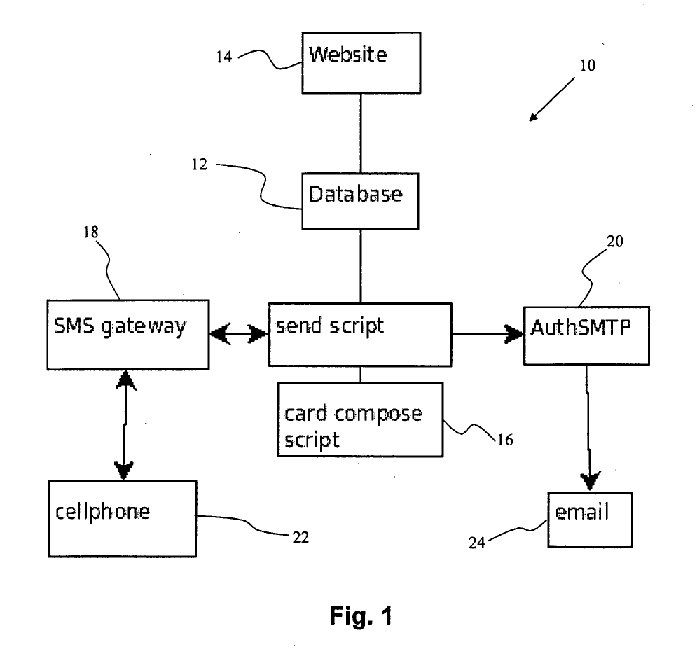

FIG. 1 depicts an exemplary structure of the preferred embodiments of the invention. As can be seen the drawing, an exemplary dropcard system 10 includes a server-database 12 in communication with a website 14 accessible for setting up user accounts as set forth in greater detail below. The dropcard system 10 further includes server-side scripts 16, a gateway 18 for sending and receiving Short Message Service (SMS) messages, and a Simple Mail Transfer Protocol (SMTP) relay service 20 for sending e-mail.

The server 12 receives and sends information, runs scripts, makes decisions, and stores database information. As is known to those skilled in the art, this can be a locally hosted server, an internet network server, or run directly off a phone or desktop computer. It is understood that the server 12 also corresponds to a plurality of servers separately or integrally.

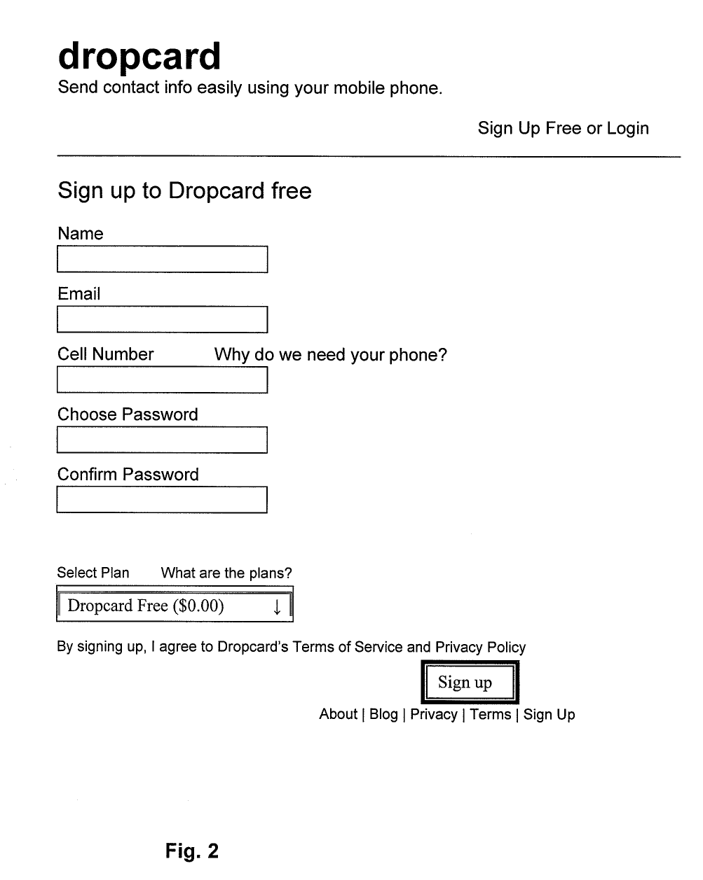

The website 14 allows users access to interact with the system 10 using a web browser for purposes of preparing and managing parts of the system for use. FIG. 2 shows an exemplary login page. As can be seen in FIG. 2, a user can self-identify and log in, for example, with an identification string (e.g., phone number, email address) and password. The user interface enables a logged-in user to securely enter all necessary information for use of the system, as described, for example, below. In particular, the user interface includes pages providing information and facilitating interactions with the system. Exemplary pages include a profile management page, an account settings page, a contact list page, and an analytics page, as would readily be understood by a skilled artisan. Further pages may include information about help guides, legal terms, and updates.

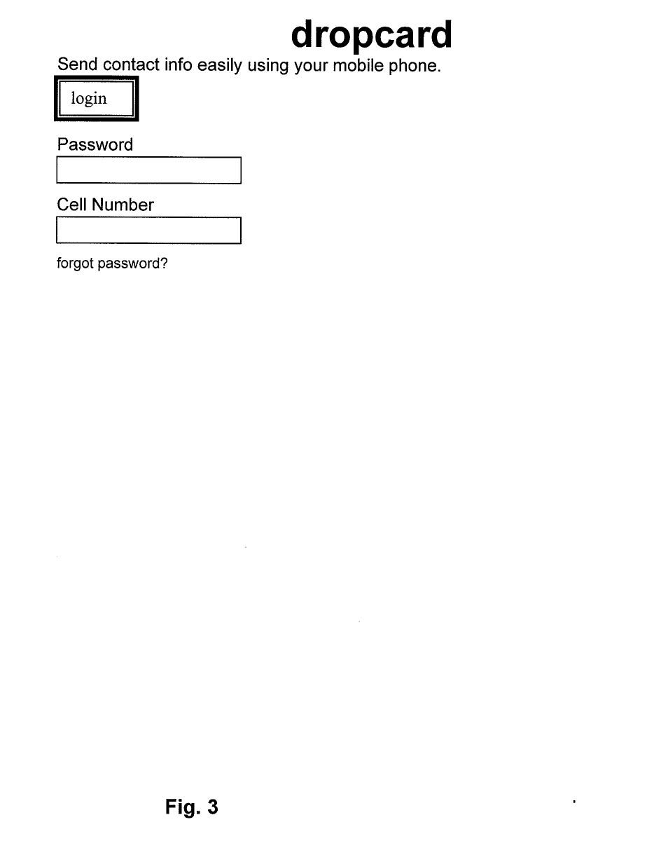

To prepare the system for interaction with a specific user, the user must register and provide information in advance of the interaction. While not being limited to a particular theory, the user provides information to create an account preferably through the web user interface as depicted in FIG. 3. In particular, FIG. 3 shows an exemplary sign-up page requesting user information, such as the user's name, phone number, email address, and password. It is understood that creating an account can also be accomplished by other means, for example, by interaction through a mobile device (without the website 14) by providing the same information through SMS messages. Users are given an account in the database and default profiles are created for them, as discussed in greater detail below. This allocates storage space for identification of all future interactions and requests.

Elements of the information provided are later used to identify future requests that originate from the registered user, for example from a phone 22 (FIG. 1) by matching the incoming phone number with the registered phone number. Requests made by others that involve the user are preferably matched using email address. This information may be updated at any time, and the user can provide additional identifying information (multiple phones, multiple email addresses, etc.).

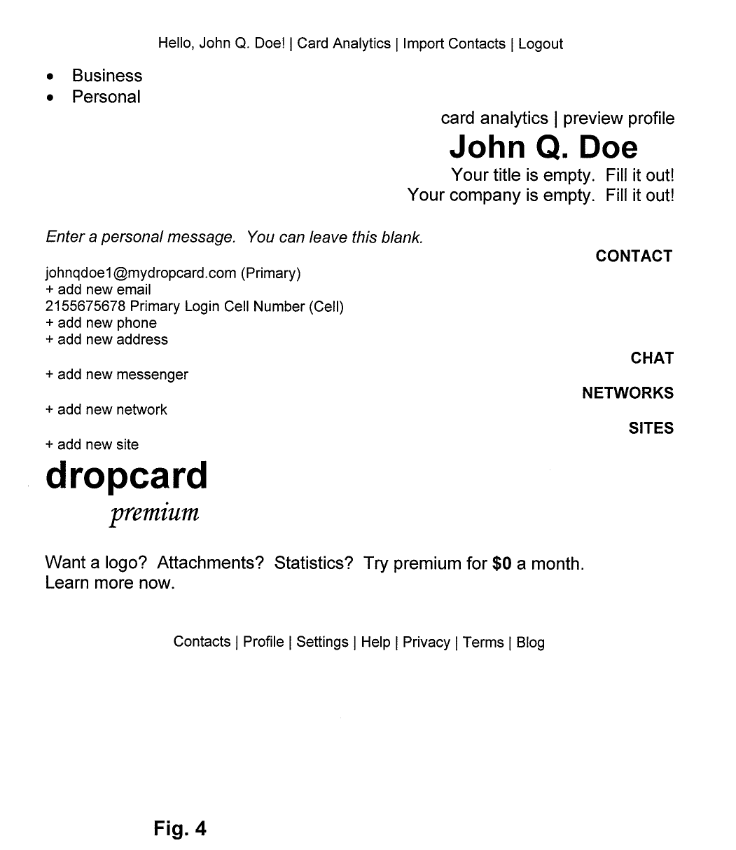

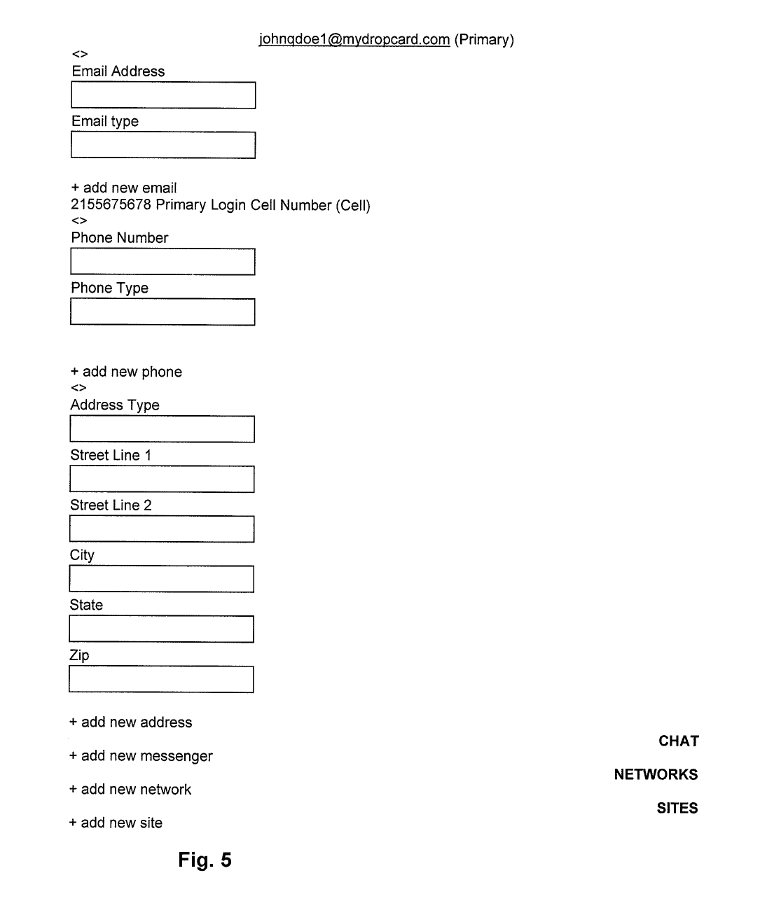

After having registered and logging into a session, the user can access a profile management page of the user interface. FIGS. 4 and 5 show exemplary profile management pages in accordance with the preferred embodiments. FIG. 5 is similar to FIG. 4, and shows drop down or up menus for entering additional information upon a user's selection to add such information. On the profile management page, the registered user inputs relevant information desired to be shared and distributed to select contacts. This information can include contact information, such as phone numbers, names, email addresses, alternate phone numbers, alternate email addresses, links to websites, social network profile Uniform Resource Locators (URLs), chat and instant message handles, Twitter URL addresses, etc. The profile management page can also include a photograph, a file or document (e.g., a resume, curriculum vitae, article), a greeting, and other chosen information. This information can be modified by the user at any time and updated, by following the same process described above of logging in and accessing the profile management page.

Still referring to FIGS. 4 and 5, users have the opportunity to create multiple profiles under the same user account. For example, the user can have separate business and personal profiles as indicated by the like named tabs shown in FIGS. 4 and 5. All information can be changed among multiple profiles and can be sent independently of one another at the user's discretion. When an additional profile is created, the user can assign a different name or signal (such as a character) that would be later used in choosing the desired profile to access or send remotely. All profile elements can be edited by simply clicking on them (e.g., selecting the desired elements) and editing their contents. New elements (e.g., another phone number) can be added by clicking or selecting the plus sign with the “add new” information tab as shown in FIG. 5. Updated information can either be updated in real-time to the database, or “saved” to the database after edits are finished.

In a preferred embodiment, the dropcard tool also enables the user to resend profile data to any or all previous recipients when the user's profile information is changed or updated. Files and documents may be uploaded by the user to the dropcard system to be stored on the server and forwarded to a recipient whenever the profile is sent.

One problem encountered by existing systems that send information to a recipient is that the form and spacing of the information is modified to fit the recipient's display. To help alleviate this problem, the dropcard system profile management page can preview a profile for the user outside the editing page to closer approximate what the recipient will see upon receipt of the profile. The user can then modify the appearance of the profile based on the preview.

When a user inputs their personal information, the system stores the information for future interaction. Before storing, the dropcard system preferably converts the external social network URLs into the corresponding add-to-network pages of the individual social networks. These add-to-network page addresses are predictable as understood by a skilled artisan, and can be written, for example: by using the information given in the standard profile URL; by using information requested by the user; or with guidance from the technical representative of a social network. The result is both a link to the user's online social network profile and a link for the recipient to directly add the user as a contact on the external online social network.

Once saved, the user's profile information is converted and encoded in HTML format and text format for sending to a potential recipient. Additionally, a vCard (VCF file) is created based on the stored profile information that can be imported by the recipient into any major contact management system, device, or address book, such as Microsoft Office Outlook. VCF is a universal format for importing contact information by software, and the same identical profile information is encoded for this potential use by the recipient.

The preferred embodiment of the invention uses SMS to cause the server to send profile information to a recipient, known as a “dropcard.” SMS is a standard format used across mobile phone manufacturers and carriers, and nearly all mobile phones today are created with SMS capability. By employing SMS as the means of contacting the server, use of the system is highly universal. Dropcard profiles can be sent by virtually anyone with a mobile phone. There are several other ways of causing the server to send a dropcard which are even more universal, as discussed in greater detail below.

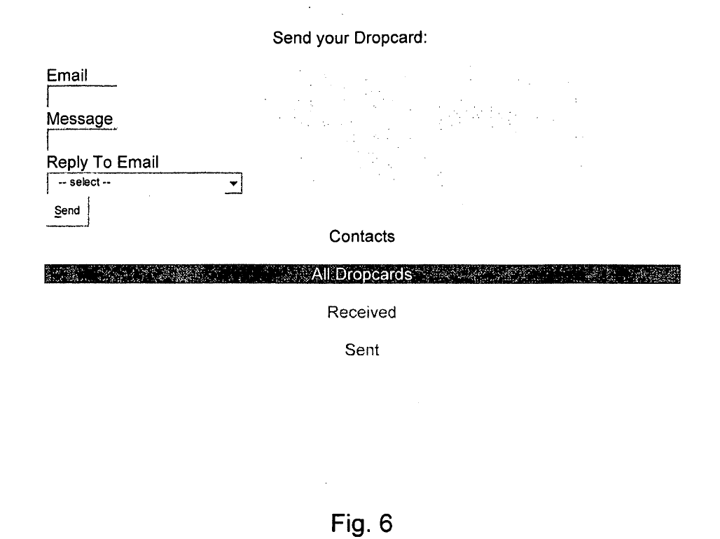

Upon identifying a recipient to send the stored information, such as a business contact, new friend, customer, or sales lead, the user only needs any phone that can send an SMS message. The user opens a new message and types in the electronic address (e.g., email address 24 (FIG. 1), phone number) of the recipient, as shown for example in the send dropcard page of FIG. 6. Additionally the user has the option to add one or multiple characters that indicate which ones of multiple dropcard profiles to send to the recipient from the database, and which files to send, if any. In order to save typing in the entire email address, users can choose from several shortcuts to represent common email address endings. For example, “johndoe@gmail.com” can be instead typed as “johndoe g” and these shortcuts are predetermined and published on the user interface. A personal note to include with the dropcard profile can be appended. There are opportunities to input other information, such as location of meeting, name of person, and personal notes to oneself as would readily be understood to a skilled artisan.

Finally, the user sends the composed SMS message addressed to a designated phone number known as an SMS short code. As an indication of success by the server in sending the dropcard, the user receives a confirmation SMS message within a short period of time, immediately following the sending of the dropcard.

While not being limited to a particular theory, the message is received by an SMS gateway connected to the recipient's carrier and relayed to the server. Depending on the implementation, the message could be received by an intermediate server as readily understood by a skilled artisan. The message content is relayed to the server with the calling of a PHP: Hypertext Preprocessor (PHP) script URL, which contains all relevant message content, primarily but not limited to the sender's phone number and the body of the message.

The script grabs the sender's phone number and the body of the SMS from the URL called by the server. The script then compares the sender phone number with the database of users for a match. If the number exists, the script proceeds to parse the message for email address, shortcuts, dropcard profile selector, file selector, and other information contained and relevant. Any information that must be converted or reformatted is processed, such as converting “johndoe g” back into “johndoe@gmail.com” Time and date are also recorded and the entire message is saved in a records database. The system may record location when possible. The script sends the user's dropcard profile specified in the SMS message (or default if none is specified) to the electronic address (e.g., email address, phone number) in the message. Finally, text confirming success is displayed in another pre-determined URL and scraped by the SMS server to send as a response text message to the sender.

Instructing and enabling the server to send a dropcard can be achieved by any method in which the user can provide input similar to the text message process described above. For example, in many cases including receiving a business card and following up later, a user can go directly to the user interface and submit input similar to a text message process, but sent directly to the server. Another manifestation is through a mobile software application which runs locally and allows the user to provide input similar to text message, but sent directly to the server through the internet. This is an application which can be downloaded to a phone, such as an iPhone or Blackberry.

Yet another manifestation for enabling the server to send a dropcard is provided by sending an email to a designated email address with a format similar to a text message (e.g., in the subject or body of the email the user provides input similar to a text message). The email is sent to an account monitored automatically by the server and parsed in a manner similar to the text message. The input in the email has more format flexibility due to greater amounts of lines, ability to go to different lines, attachments, and thus a different format is possible for user input.

Another option for enabling the server to send a dropcard is to use a phone which is not SMS enabled. The user calls a designated phone number and either orally spells the email address and any other inputs, or dials the alphabetical equivalent. Through either or a combination, the user is able to provide input similar to that described above.

Once the request is made, the recipient and both profile-to-be-sent are identified, and the outgoing email message is composed using the profile's data. In the preferred embodiment this is achieved with a call to a separate message composition script. The generated message contains the profile information formatted in HTML, with additional hyperlinks to allow recipients to register themselves, and possibly advertisements appended to the message. Additionally each hyperlink is encoded so that when clicked, the user is redirected to a script on the server and next to the target website, as discussed by example below.

The original script also checks if the recipient is already registered. If the recipient is registered and with prior recipient permission given, the server calls that dropcard profile and sends it to the sender's registered email address using the message composition script. This information is included in the confirmation email.

The dropcard profile is attached with the encoded VCF vCard file and any pre-selected files and documents. To send the information and attachments via email, an email class is used to connect to an SMTP server and send the primary email, as well as the reciprocal or confirmation email, as would be readily understood by a skilled artisan. The preferred embodiment uses an authenticated SMTP mail service to prevent the message from being blocked as spam mail.

Once the request is made and processed by the server, the recipient receives the dropcard profile information in email, text message, phone call, or by mobile local software. The server simultaneously sends a confirmation message to the sender in any of the above forms. In the event that the recipient is also a registered user, and has given permission, the sender receives the recipient's default information reciprocally.

In the dropcard profile, the hyperlinks are encoded such that the user is redirected to a script on the server and next to the target website. In other words, any link clicked on by the recipient is routed through a server URL first, and this is recorded with the user, the link, the dropcard profile, and the time associated with the recipient's action. It is also possible to save the information that the email was opened in general. This information is all recorded because the encoded URL is unique to the dropcard itself, the sender, and the recipient, and the individual dropcard of that time, and other embedded information.

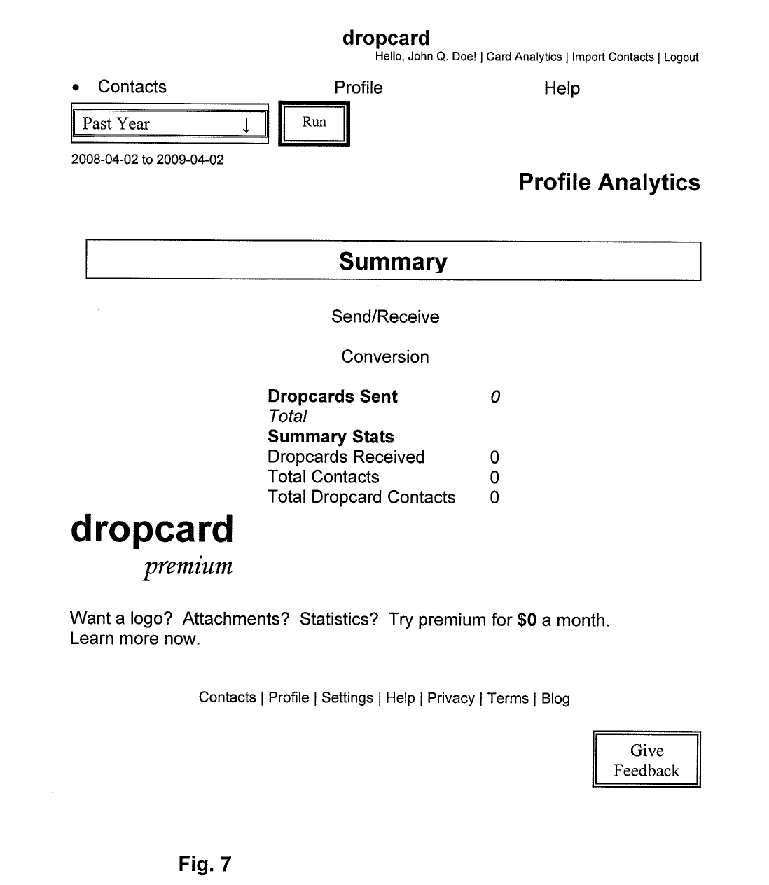

While not being limited to a particular theory, the records of the user's selections and recipient actions are stored in the database for purposes of displaying as results and statistics to the sender, for example as shown in the profile analytics page of FIG. 7. The same basic records are analyzed by various scripts in different ways according to user preference. They are generated into numbers formats, graphical representations, and embedded into the user interface for viewing by the sender. These records can be recalled and viewed as aggregate statistics and figures representing the overall performance and results of each sent dropcard profile. The figures can be compiled centered around the recipient, the sender, a particular link, or on the dropcard profile overall. Example figures include profiles sent, received, opened, conversion of clicks from profiles, and percentage of times a profile was opened that the link was clicked. Many other display combinations and comparisons may also be made as are useful to the user, including comparisons over time, and other tied-in results that may have occurred external to the system. A practical significance of such features is that the sender will have access to potentially valuable intelligence concerning the recipient's interest in information provided on the sender's dropcard.

A list of sent dropcard profiles may also be viewed by the user, in the form of a contacts list. Contacts comprise both sent and received dropcards. A received dropcard is sent by another registered user to an email address that corresponds to the main user's account.

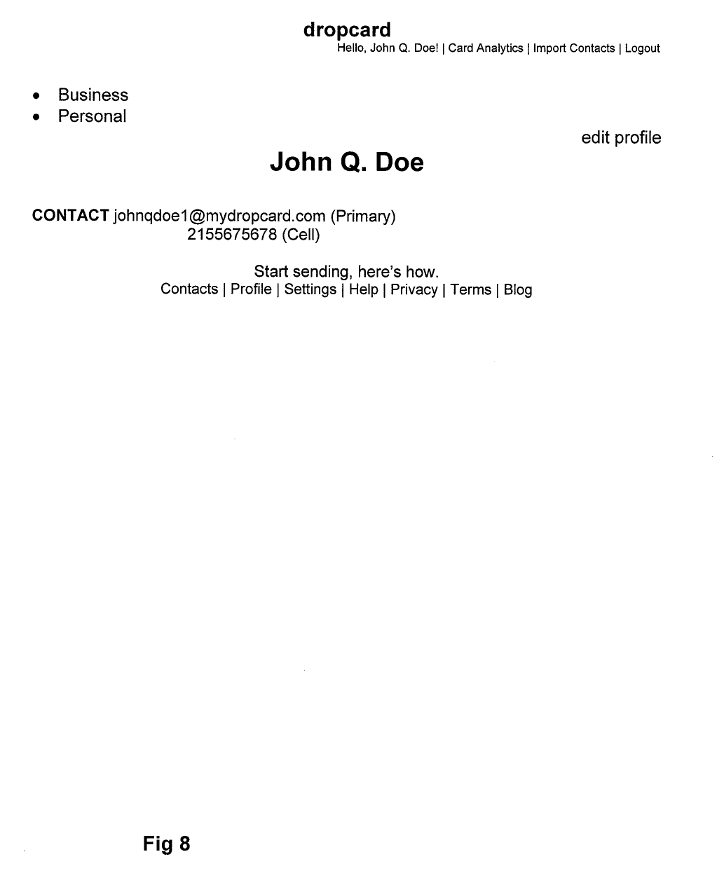

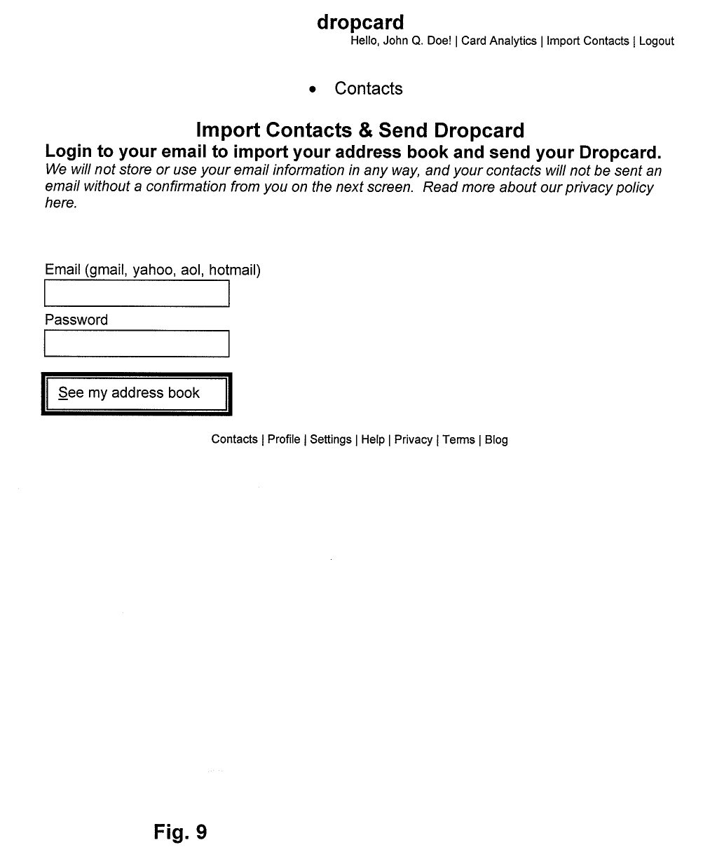

FIG. 8 depicts an exemplary contact list page. The contact list sorts available and downloadable vCard VCF files. Contacts can be sorted by date, received, and sent, and any other category which is useful to the user. Contacts may also be imported from outside services by the user, as shown for example in the imports contact page of FIG. 9. As is known by those skilled in the art, users can log in to their individual email provider such as Gmail, AOL, Yahoo, or Hotmail, and authenticate the transfer of pre-existing contact information. They can both import contacts and allows mass-sending of dropcards to their contact lists. Moreover, collected contact information and statistical information can be imported and automatically or manually transferred to CRM software for seamless continual use by the user in external programs and uses.

Users have the ability, through the user interface, to enable additional phone numbers the server can recognize, from which to send profiles. They may also change their login information, enable a publicly accessible dropcard profile page which can be sent to others, and enable automatic reciprocal sending as mentioned above. Other setting types include changing account level and billing, and whether confirmation emails should be sent.

It is understood that the dropcard system and method for enabling an individual to immediately send contact and other information using a mobile phone described and shown are exemplary indications of preferred embodiments of the invention, and are given by way of illustration only. In other words, the concept of the present invention may be readily applied to a variety of preferred embodiments, including those disclosed herein. While the invention has been described in detail and with reference to specific examples thereof, it will be apparent to one skilled in the art that various changes and modifications can be made therein without departing from the spirit and scope thereof. Without further elaboration, the foregoing will so fully illustrate the invention that others may, by applying current or future knowledge, readily adapt the same for use under various conditions of service.

What is claimed is:

1. A dropcard system that enables a user to send an electronic dropcard using a phone to a recipient's electronic address, comprising:
a website accessible to the user for setting up an account for the user, the account including an identification string and profile information of the user;
a first server in communication with the website and having a processor and a memory unit storing a database and server-side scripts, the server storing the identification string and profile information of the user and creating a VCF vCard based on the stored profile information; and
a gateway in communication with the first server, the gateway receiving an SMS message initiated from the phone and forwarding the SMS message to the first server, the SMS message including a phone number associated with the user and an electronic address of the recipient,
the server-side scripts matching the phone number with the identification string stored in the server, parsing the SMS message for data relevant to contact information of the recipient and for user selected instructions for identifying user information in the database, saving the parsed SMS message in the database, collecting profile information of the user from the database based on the user information identified by the selected instructions as an electronic dropcard, and sending the electronic dropcard to the electronic address of the recipient.

2. The dropcard system of claim 1, further comprising a second server receiving the dropcard attached message from the first server and forwarding the dropcard attached message to an email address corresponding to the recipient.

3. The dropcard system of claim 2, wherein the second server is a SMTP server.

4. The dropcard system of claim 1, the dropcard attached message including an electronic copy of the VCF vCard.

5. A method for sending an electronic dropcard initiated by a phone call to a recipient's electronic address, comprising:
(a) receiving an SMS message at a server from a phone making the phone call, the SMS message including a phone number associated with the phone, user selected instructions and an electronic address associated with a recipient;
(b) matching the phone number with an identification string stored in a database of the server, the identification string associated with a user of the phone initiating the phone call;
(c) parsing the SMS message for the electronic address of the recipient and for user selected instructions for identifying profile information of the user in the database;
(d) saving the parsed SMS message in the database;
(e) collecting the profile information of the user from the database based on the user information identified by the selected instructions as an electronic dropcard; and
(f) sending the electronic dropcard to the electronic address of the recipient.

6. The method of claim 5, further comprising, before step (a), receiving and storing the phone number associated with the phone and the profile information associated with the user of the phone.

7. The method of claim 5, the SMS message being relayed to the server using a PHP script URL.

8. The method of claim 5, further comprising, before step (a), storing a plurality of profiles as the profile information associated with the user.

9. The method of claim 5, further comprising, before step (a), storing files and documents associated with the user on the server and sending selected ones of the stored files and documents with the electronic dropcard to the electronic address of the recipient.

10. The method of claim 5, further comprising, before step (a), creating and storing a vCard based on the stored profile information associated with the user on the server and sending the vCard with the electronic dropcard to the electronic address of the recipient.

11. The method of claim 5, further comprising, sending personal notes identified in the SMS message with the electronic dropcard to the electronic address of the recipient.

12. The method of claim 5, further comprising, matching the electronic address associated with the recipient with an electronic address of another registered user, and sending profile information of the other registered user to the phone.

13. A server comprising a database and a processor running server-side scripts for sending an electronic dropcard initiated by a phone call to a recipient's electronic address, the server receiving an SMS message at a server from a phone making the phone call, the SMS message including a phone number associated with the phone, user selected instructions and an electronic address associated with a recipient, matching the phone number with an identification string stored in the database, the identification string associated with a user of the phone initiating the phone call, parsing the SMS message for the electronic address of the recipient and for user selected instructions for identifying profile information of the user in the database, saving the parsed SMS message in the database, collecting the profile information of the user from the database based on the user information identified by the selected instructions as an electronic dropcard, and sending the electronic dropcard to the electronic address of the recipient.

14. The server of claim 13, further comprising the server running server-side scripts for receiving and storing the phone number associated with the phone and the profile information associated with the user of the phone.

15. The server of claim 13, the SMS message being relayed to the server using a PHP script URL.

16. The server of claim 13, further comprising the server running server-side scripts for storing a plurality of profiles as the profile information associated with the user.

17. The server of claim 13, further comprising the server running server-side scripts for storing files and documents associated with the user on the server and sending selected ones of the stored files and documents with the electronic dropcard to the electronic address of the recipient.

18. The server of claim 13, further comprising the server running server-side scripts for creating and storing a vCard based on the stored profile information associated with the user on the server and sending the vCard with the electronic dropcard to the electronic address of the recipient.

19. The server of claim 13, further comprising the server running server-side scripts for sending personal notes identified in the SMS message with the electronic dropcard to the electronic address of the recipient.

20. The server of claim 13, further comprising the server running server-side scripts for matching the electronic address associated with the recipient with an electronic address of another registered user, and sending profile information of the other registered user to the user of the phone initiating the phone call.
